(19) United States
(12) Patent Application Publication
(10) Pub. No.: US 2025/0001993 A1
(43) Pub. Date: Jan. 2, 2025

(54) FAULT DIAGNOSTIC SYSTEM OF AIR SPRING BRAKE CHAMBER FOR VEHICLE

(71) Applicant: MIRAEVC CO., LTD., Jeollabuk-do (KR)

(72) Inventors: Seung Hoon LEE, Jeollabuk-do (KR); Soon sik MYUNG, Jeollabuk-do (KR); Byung Yong KANG, Jeollabuk-do (KR)

(21) Appl. No.: 18/278,663

(22) PCT Filed: Nov. 15, 2022
(86) PCT No.: PCT/KR2022/017922

§ 371 Date: Aug. 24, 2023

(30) Foreign Application Priority Data
Oct. 25, 2022 (KR) 10-2022-0137895

(51) Int. Cl. B60T 17/22; B60Q 9/00; F16D 66/00

(52) U.S. Cl. CPC B60T 17/22; B60Q 9/00; F16D 66/00; F16D 2066/001; F16D 2066/005

(57) ABSTRACT

A fault diagnostic system of an air spring brake chamber for vehicles according to an embodiment includes a pressure measurement unit configured to measure a pressure in each of a parking chamber between a piston and an adaptor housing and a service chamber between the adaptor housing and a diaphragm; a brake lining temperature sensing unit connected to a brake lining to detect a temperature of the brake lining; and a notification unit configured to generate an alarm about an abnormal situation in the brake based on a pressure measurement value of the pressure measurement unit and a temperature measurement value of the lining temperature sensing unit.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/017922, filed Nov. 15, 2022, which claims priority to the benefit of Korean Patent Application No. 10-2022-0137895 filed in the Korean Intellectual Property Office on Oct. 25, 2022, the entire contents of which are incorporated herein by reference.

### BACKGROUND

### 1. Technical Field

The present disclosure relates to a fault diagnostic system of an air spring brake chamber for vehicles, and more particularly, to a fault diagnostic system of an air spring brake chamber for vehicles for monitoring changes in abnormal situation in the air spring brake chamber for vehicles based on measurement values of a plurality of pressure sensors which measures the pressure in a pressure chamber and a service chamber and a brake lining temperature sensing unit which detects the brake lining temperature.

### 2. Background Art

Large scale vehicles such as buses, trucks, trailers and other heavy machine use automotive brake chambers that can provide sensitive and fast braking action while driving at high speed or parking and outstanding braking performance.

In relation to the automotive brake chamber, Korean Patent No. 10-1567709 discloses a brake actuator. The automotive brake chamber includes a hollow head housing, an adaptor housing and a bottom housing in a sequential order from top. Meanwhile, a piston is disposed between the head housing and the adaptor housing, and a hollow actuator rod is coupled to the piston and disposed through a through-hole of the adaptor housing. A diaphragm is disposed between the adaptor housing and the bottom housing. Additionally, a pressure plate supports the diaphragm, and a push rod supports the pressure plate. The push rod is disposed through a through-hole of the bottom housing.

Through this structure, a space between the head housing and the piston is a spring chamber, and a spring is disposed between them. A space between the piston and the adaptor housing is a pressure chamber. A space between the adaptor housing and the diaphragm is a service chamber, and a pushrod chamber is formed between the diaphragm and the bottom housing.

As described above, the automotive brake chamber includes the spring chamber, the pressure chamber, the service chamber and the pushrod chamber from top to bottom, and the pushrod connected through the lower end of the bottom housing moves with the upward and downward movement of the pressure plate by the adjustment of the elastic force of the spring and the air pressure in the service chamber in order to brake on the vehicle while driving or parking.

In this instance, the pushrod plays a role in braking as it moves up and down, and when there is a problem with the braking action, a change occurs in the pushrod stroke. However, the brake actuator of Korean Patent No. 10-1567709 does not have any configuration for determining if there is a fault or a small change in the pushrod stroke, thereby failing to repair the pushrod chamber beforehand.

### SUMMARY

The present disclosure relates to a fault diagnostic system of an air spring brake chamber for vehicles for monitoring changes in abnormal situation in the air spring brake chamber for vehicles based on measurement values of a plurality of pressure sensors which measures the pressure in a parking chamber and a service chamber and a brake lining temperature sensing unit which detects the brake lining temperature.

To achieve the above-described objective, there is provided a fault diagnostic system of an air spring brake chamber for vehicles according to the present disclosure, in which the air spring brake chamber for vehicles includes a head housing, a bottom housing and an adaptor housing between the head housing and the bottom housing, a piston between the head housing and the adaptor housing, and a diaphragm secured between the adaptor housing and the bottom housing to divide a space between the adaptor housing and the bottom housing, the fault diagnostic system including: a pressure measurement unit configured to measure a pressure in each of a parking chamber between the piston and the adaptor housing and a service chamber between the adaptor housing and the diaphragm; a brake lining temperature sensing unit connected to a brake lining to detect a temperature of the brake lining; and a notification unit configured to generate an alarm about an abnormal situation in the air spring brake chamber for vehicles based on a pressure measurement value of the pressure measurement unit and a temperature measurement value of the lining temperature sensing unit.

The notification unit generates the alarm about the abnormal situation in the air spring brake chamber for vehicles when a parking pressure value detected in at least one of a plurality of parking chambers at a plurality of wheels of a vehicle is equal to or lower than a predetermined pressure, and a service pressure value detected in at least one of a plurality of service chambers at the plurality of wheels of the vehicle is maintained at or above a predetermined pressure for a predetermined time or a pressure difference of each service chamber is equal to or larger than a predetermined value.

The brake lining temperature sensing unit classifies the temperature detected in the brake lining into stages or sets a temperature resistance table and determines the faulty brake when the temperature corresponds to a specific stage or a specific condition.

The fault diagnostic system of the air spring brake chamber for vehicles further includes a warning lamp unit configured to receive data from the pressure measurement unit and the brake lining temperature sensing unit and turn on a warning lamp according to the pressure or temperature, wherein the warning lamp unit provides the data of the corresponding vehicle to a control center or a nearby vehicle when a user did not check although a predetermined time has passed since the warning lamp was turned on.

Recording is made that an emergency brake has operated when the pressure value detected in the parking chamber drops from 69 psi down to 10 psi within 1 second, or the pressure value detected in the service chamber is instantaneously 72 psi or more.

The pressure sensing system of the air spring brake chamber for vehicles according to the present disclosure as described above may monitor pressure changes in real time in a state that the plurality of pressure sensors which measures the pressure in the parking chamber between the piston and the adaptor housing and the service chamber between the adaptor housing and the diaphragm is connected to the indicator at the driver's seat.

### BRIEF DESCRIPTION OF THE DRAWINGS

FIG. 1 is a diagram showing a configuration of an air spring brake chamber for vehicles according to an embodiment of the present disclosure.

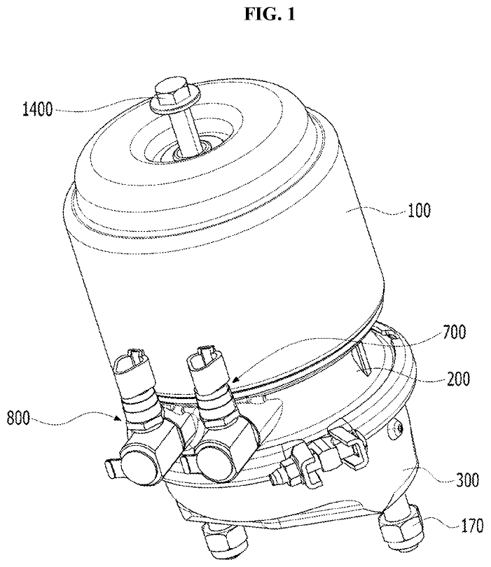

FIG. 2 is a cross-sectional view of the air spring brake chamber for vehicles shown in FIG. 1.

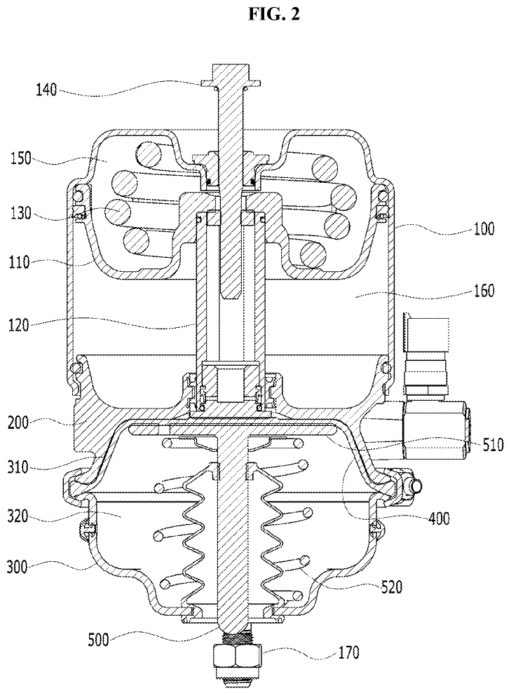

FIG. 3 is a diagram showing the coupling of a service unit sensor connected to a service unit chamber in the air spring brake chamber for vehicles shown in FIG. 1.

FIG. 4 is a diagram showing the coupling of a pressure sensor connected to a parking chamber in the air spring brake chamber for vehicles shown in FIG. 1.

FIG. 5 shows a pressure measurement unit, a brake lining temperature sensing unit and a warning lamp unit connected to a control box.

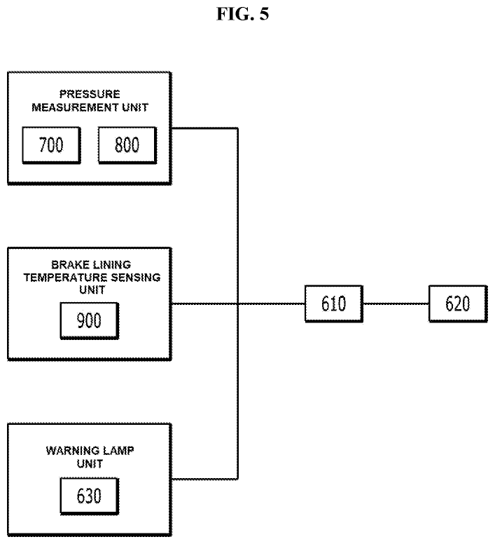

FIG. 6 shows a process of monitoring pressure changes in real time in a state that a plurality of pressure sensors is connected to an indicator at the driver's seat.

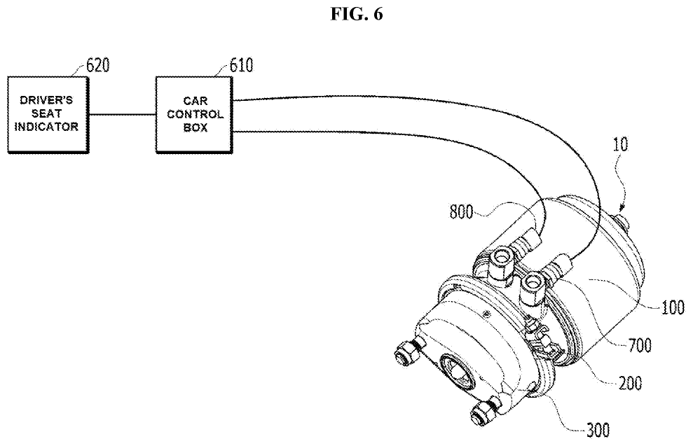

### DETAILED DESCRIPTION

Hereinafter, the embodiments of the present disclosure will be described in more detail with reference to the accompanying drawings. However, the present disclosure is not limited to the following disclosed embodiments and will be embodied in a variety of different forms, and these embodiments are provided so that this disclosure will be thorough and complete, and will fully convey the scope of the present disclosure to those skilled in the art. In the drawings, the same reference sign denotes the same element.

In adding the reference signs to the elements in each drawing, it should be noted that identical elements have reference signs that are as identical as possible although they appear in different drawings. Additionally, in describing the present disclosure, when it is determined that a certain detailed description of relevant known elements or functions may obscure the subject matter of the present disclosure, the detailed description is omitted.

First, an air spring brake chamber for vehicles includes a hollow head housing 100, an adaptor housing 200 and a bottom housing 300 in a sequential order from top, a piston 110 is disposed between the head housing 100 and the adaptor housing 200, and a diaphragm 400 is disposed between the adaptor housing 200 and the bottom housing 300.

Meanwhile, an actuator rod 120 has a through-hole that passes through the adaptor housing 200 in the downward direction of a piston through-hole of the piston 110, and a rod valve is disposed at the end of the actuator rod 120. The rod valve communicates a spring chamber 150 with a service chamber 310 to allow air to flow. In this embodiment, the piston 110 and the actuator rod 120 are separately formed, but they may be integrally formed.

The air spring brake chamber for vehicles allows air to flow between the spring chamber 150 and the service chamber 310 through the hollow actuator rod 120 between the spring chamber 150 and the service chamber 310 and the actuator rod valve coupled to the lower end of the actuator rod 120.

The air spring brake chamber for vehicles includes the spring chamber 150 between the head housing 100 and the piston 110, and a parking chamber 160 between the piston 110 and the adaptor housing 200. Additionally, the air spring brake chamber for vehicles includes the service chamber 310 between the adaptor housing 200 and the diaphragm 400, and a pushrod chamber 320 between the diaphragm 400 and the bottom housing 300.

A compression spring 130 disposed in the spring chamber 150 is a coil spring, and as it goes from the center of the coil toward two ends, the outer diameter of the coil may decrease. In this instance, one end of the compression spring 130 is supported in contact with the piston 110, and the other end of the compression spring 130 is supported in contact with a curved part of the head housing 100.

Meanwhile, the curved part is formed along the inner side of the head housing 100 at the top portion of the head housing 100, and the curved part prevents the compression spring 130 from moving out of position at the upper part, so the compression spring 130 always maintains the constant center axis when compressed.

The piston 110 is placed in close contact with the inside of the head housing 100 and separates the internal space of the head housing 100 into the spring chamber 150 and the parking chamber 160. The hollow actuator rod 120 is disposed in one direction along the piston through-hole. Accordingly, one end of the actuator rod 120 may be supported in connection to the piston 110 and the other end may be supported on the diaphragm 400 through the through-hole of the adaptor housing 200.

A lip seal 122 is disposed to prevent fluid leaks at the area of contact between the outer circumferential surface of the actuator rod 120 and the inner circumferential surface of the adaptor housing 200. That is, the lip seal 122 is assembled in the through-hole at the center of the adaptor housing 200, and the actuator rod 120 operates through the lip seal 122. The lip seal 122 performs a sealing function to prevent the movement of air pressure between the parking chamber and the service chamber.

Inside the actuator rod 120, a caging bolt 140 is disposed at one end and a caging nut is disposed at the other end, wherein the caging bolt 140 is driven into a head housing through-hole of the head housing 100 and disposed along the through-hole of the adaptor housing 200, and the caging nut is screw-coupled to the caging bolt 140.

The caging bolt 140 functions to forcibly compress a power spring, and is used to mount or forcibly unpark the vehicle in the absence of air pressure. The drawing shows the forcibly compressed fixed state, and after mounted in the vehicle, for the normal operation, the caging bolt is tightly fastened to the chamber head, that is to say, the caging bolt does not protrude.

A mounting bolting structure 170 functions to secure the air spring brake chamber for vehicles to a bracket or a caliper of the vehicle. The mounting bolting structure 170 has a mounting bolt and a mounting nut.

The adaptor housing 200 is disposed between the head housing 100 and the bottom housing 300 to connect the head housing 100 to the bottom housing 300. The adaptor housing 200 has the through-hole at the center, and the actuator rod 120 passes through the through-hole and is supported in contact with the diaphragm 400. A valve structure 210 may be disposed on one side of the adaptor housing 200 to allow air pressure to enter, and when the parking brake is applied at the driving stage of the vehicle, air may be allowed to enter.

Meanwhile, the diaphragm 400 is disposed in the bottom housing 300 and supported in contact with a pushrod plate 510, and divides the bottom housing 300 into the service chamber 310 and the pushrod chamber 320. In this instance, the pushrod plate 510 is supported by a pushrod 500, and plays a role in transmitting the air pressure-driven movement of the diaphragm 400 to the pushrod 500. A pushrod spring 520 is disposed along the axial direction of the pushrod 500 between the pushrod plate 510 and the bottom housing 300 and is compressed or restored with the movement of the pushrod plate 510.

The fault diagnostic system of the air spring brake chamber for vehicles according to an embodiment of the present disclosure further includes a pressure measurement unit having a plurality of pressure sensors to measure the pressure in the parking chamber and the service chamber, a brake lining temperature sensing unit 900 connected to a brake lining of the vehicle to detect the brake lining temperature, a control box 610 electrically coupled to the plurality of pressure sensors, and an indicator 620 electrically coupled to the control box to generate an alarm about an abnormal situation in the air spring brake chamber for vehicles based on the pressure measurement value of the pressure measurement unit and the temperature measurement value of the lining temperature sensing unit.

The control box 610 has wiring connection for communication with the pressure sensor disposed in each of the parking chamber and the service chamber, reception of measurement data from the pressure sensor in electrically connected state, data analysis, and power supply to the pressure sensor and output voltage. Meanwhile, the wire connection may be made by a wired method between the pressure sensor and the control box, and a wireless communication method may be also possible.

When a parking pressure value detected in at least one of a plurality of parking chambers at the plurality of wheels of the vehicle is equal to or less than a predetermined pressure, and a service pressure value detected in at least one of a plurality of service chambers at the plurality of wheels of the vehicle is maintained at or above a predetermined pressure for a predetermined time or a pressure difference of each service chamber is equal to or larger than a predetermined value, the control box 610 generates an alarm about an abnormal situation in the air spring brake chamber for vehicles through the indicator 620 that may be disposed at the driver's seat.

The present disclosure further includes a warning lamp unit 630 to receive data from the pressure measurement unit and the brake lining temperature sensing unit and turn on the warning lamp according to the pressure or temperature, and when the user did not check although a predetermined time has passed since the warning lamp was turned on, the warning lamp unit provides the data of the corresponding vehicle to a control center or a nearby vehicle of the corresponding vehicle.

The plurality of pressure sensors includes a first pressure sensing module 700 in communication with the service chamber 310 and a second pressure sensing module 800 in communication with the parking chamber 160. The first pressure sensing module 700 and the second pressure sensing module 800 may be disposed side by side on one outer side of the adaptor housing 200, facing the same direction.

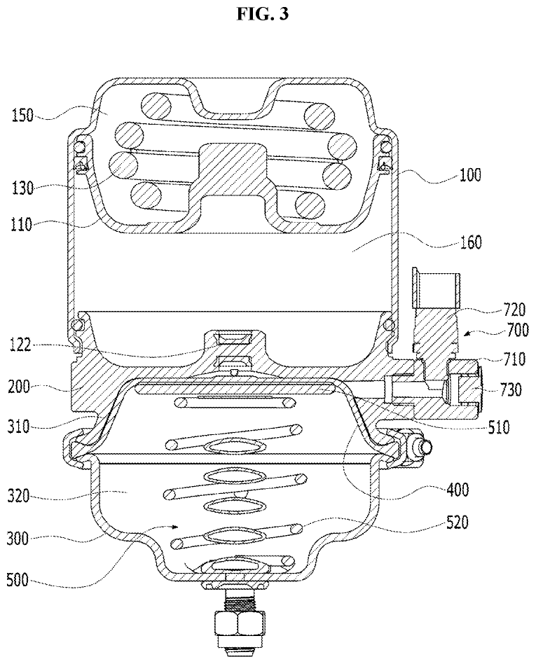

Referring to FIG. 3, the first pressure sensing module 700 includes a first connector 710 separably coupled to the outer side of the adaptor housing 200 and being in communication with the service chamber 310, a first pressure sensor 720 coupled in communication with an inner channel of the first connector 710, and a first cover 730 coupled to an outer end in communication with the inner channel of the first connector 710. The first connector 710 is assembled in a first port formed to the service chamber 310 in the adaptor housing 200, and the first pressure sensor 720 is screw-coupled to the first connector 710.

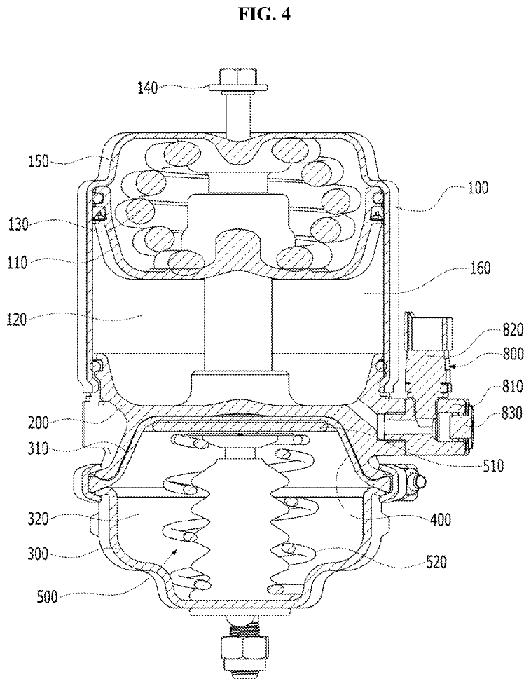

Referring to FIG. 4, the second pressure sensing module 800 includes a second connector 810 separably coupled to the outer side of the adaptor housing 200 and being in communication with the parking chamber 160, a second pressure sensor 820 coupled in communication with an inner channel of the second connector 810, and a second cover 830 coupled to an outer end in communication with the inner channel of the second connector 810. The second connector 810 is assembled in a second port formed to the parking chamber 160 in the adaptor housing 200, and the second pressure sensor 820 is screw-coupled to the second connector 810.

Meanwhile, in another embodiment, the first and second pressure sensors 720, 820 of the first and second pressure sensing modules 700, 800 may be directly connected to the adaptor housing 200 without the connectors 710, 810.

When the outside air pressure is filled in the service chamber, it causes the diaphragm 400 (membrane) to expand, and when it acts on the pushrod plate 510, the pushrod 500 moves downward.

When the outside air pressure is fed and filled in the parking chamber 160, it is transmitted to the total area of the piston 110 and the edge seal of the piston to compress the compression spring 130 which is a power spring.

Hereinafter, abnormal situation detection in the plurality of parking chambers and the plurality of service chambers at the plurality of wheels of the vehicle will be described.

### Example 1

First, the fault detection conditions of the plurality of parking chambers will be described with reference to the following Table 1.

The speed of the vehicle is maintained at 5 mi/h. Specifically, the speed of the vehicle refers to the speed of 5 mi/h or more to detect the movement of the vehicle.

When the parking pressure value detected in at least one of the plurality of parking chambers at the plurality of wheels of the vehicle drops down to a preset unparking pressure, a warning is generated. For example, the unparking pressure may be 69 psi. Specifically, in this case, a pressure difference may occur between four parking chambers. For example, the normal pressure is pressure equal to the unparking pressure, and the abnormal pressure is pressure lower than the unparking pressure. When the pressure drops from the unparking pressure down to the minimum instantaneous pressure, emergency brake recordings are made. For example, when the pressure drops from 69 psi down to 10 psi within 1 second, emergency brake recordings are made.

TABLE 1

| | | | | | | Emergency | | | |
|---|---|---|---|---|---|---|---|---|---|
| | Pressure (psi): Standard | | | | | brake | | | |
| | pressure 69 psi (normal) | | | | | records | | | |
| | | NG condition (standard | | | | (when it | | | |
| | | and normal pressure | | | | occurs | | | |
| | | difference occurrence) | | | | within 1 | Speed | Time | |
| Classification | Normal | 1 | 2 | 3 | 4 | second) | (mi/h) | (s) | Location |
| FL-P | 69↑ | 59↓ | 69↑ | 69↑ | 69↑ | 10↓ | 5 mi/h↑ | 60 s↑ | Location |
| FR-P | 69↑ | 59↓ | 69↑ | 69↑ | 59↓ | 10↓ | 5 mi/h↑ | 60 s↑ | recording |
| RL-P | 69↑ | 59↓ | 69↑ | 59↓ | 59↓ | 10↓ | 5 mi/h↑ | 60 s↑ | when |
| RR-P | 69↑ | 59↓ | 59↓ | 59↓ | 59↓ | 10↓ | 5 mi/h↑ | 60 s↑ | storing |
| | | | | | | | | | data |

### Example 2

The fault detection conditions of the plurality of service chambers will be described with reference to the following Table 2.

The speed of the vehicle is maintained at 5 mi/h. Specifically, the speed of the vehicle refers to the speed of 5 mi/h or more to detect the movement of the vehicle.

When the service pressure value, i.e., the braking pressure value detected in at least one of the plurality of service chambers at the plurality of wheels of the vehicle is maintained or a pressure difference of each service chamber occurs, a warning is generated. For example, currently, the pressure value is not set, but when the service pressure value is maintained at or above a predetermined pressure of 29 psi for a predetermined time of 60 s or a pressure difference of each service chamber is equal to or larger than a predetermined value of 10 psi, a warning is generated. Specifically, in this case, the pressure difference may occur between four service chambers. For example, when a preset emergency high pressure value, not an ordinary brake pressure, is instantaneously detected (for example, 72 psi or more is detected), emergency brake recordings are made.

TABLE 2

| | Pressure (psi) | | | | | | | |
|---|---|---|---|---|---|---|---|---|
| | | When a | | | | | | |
| | | pressure | | | | | | |
| | | difference | | | | | | |
| | | occurs | | | | | | |
| | | When a | | | | | | |
| | For | difference of | | | Emergency | | | |
| | 60 s or | 10 psi or more | | | brake | Speed | Time | |
| Classification | longer | occurs | | | records | (mi/h) | (s) | Location |
| FL-P | 29↑ | 15 | 15 | 15 | 72↓ | 5 mi/h↑ | 60 s↑ | Location |
| FR-P | 29↑ | 15 | 15 | 5 | 72↓ | 5 mi/h↑ | 60 s↑ | recording |
| RL-P | 29↑ | 15 | 5 | 5 | 72↓ | 5 mi/h↑ | 60 s↑ | when |
| RR-P | 29↑ | 5 | 5 | 5 | 72↓ | 5 mi/h↑ | 60 s↑ | storing |
| | | | | | | | | data |

That is, records are created that the emergency brake has operated when the pressure value detected in the parking chamber drops from 69 psi down to 10 psi within 1 second, or the pressure value detected in the service chamber is instantaneously detected above 72 psi.

When the pressure in at least one of the plurality of parking chambers is 69 psi or less at the speed of the vehicle of 5 mi/h, the indicator 620 determines that there is a fault in the brake chamber, and when the chamber pressure in at least one of the plurality of service chambers is maintained at or above 29 psi for 60 s or more at the speed of the vehicle of 5 mi/h, or a pressure difference of each service chamber is 10 psi or more, the indicator 620 determines that there is a fault in the brake chamber.

The brake lining temperature sensing unit classifies the temperature detected in the brake lining into stages, or sets a temperature resistance table and determines that there is a fault in the brake when the temperature corresponds to a specific stage or a specific condition. The temperature rise in the brake lining may occur during continuous braking on downhill, and when the pressure in the parking chamber drops down to the set unparking pressure value, the temperature rises and overheating occurs, and when the pressure in the service brake chamber is continuously maintained at or above the set braking pressure value for a long time while driving, the pressure detection and the temperature detection correlate due to overheating.

Specifically, the thermal sensor sets and manages three over-temperature stages, for example, normal, alert and overheating (temperature at which a fire occurs in friction material).

The temperature resistance table is set and applied.

The control box provides the pressure in the parking chamber and the service chamber or the temperature of the brake lining to a mobile terminal or a web server via a network to indicate whether there is a fault in the brake. Meanwhile, wire connection may be made by a wired method between the pressure sensor, the thermal sensor and the control box, and a wireless communication method may be also possible.

The control box indicates whether there is a fault in the brake by controlling the warning lamp to turn on/off according to the pressure in the parking chamber and the service chamber, and indicates whether there is a fault in the brake by controlling the warning lamp to turn on/off according to the temperature of the brake lining.

Meanwhile, when a fault in the pushrod 500 stroke is determined, the control box 610 may transmit the condition of the spring brake chamber to an electronic control unit (ECU) of the vehicle connected to the control box 610, and the electronic control unit may request inspection of the spring brake chamber 10 through a display unit or an audio player of the vehicle.

In this instance, the control box 610 may be connected to the electronic control unit through a wireless communication module 640. That is, when the spring brake chamber needs to be inspected, the control box 610 may transmit the inspection of the spring brake chamber to the electronic control unit (ECU) of the vehicle using the wireless communication module, and the electronic control unit may notify an inspection signal through the display unit or the audio player disposed in the vehicle.

As described above, since the plurality of pressure sensors and the control box 610 are connected to each other, it may be possible to identify the normal operation of the brake by monitoring the pressure in the pressure chamber and the service chamber in real time, thereby detecting air pressure changes in at least one of the spring chamber 150, the parking chamber 160, the service chamber 310 or the pushrod chamber 320, or changes in movement of the pushrod 500 caused by damage of the diaphragm 400. Accordingly, it may be possible to prevent accidents caused by the faulty brake by determining the condition of the brake through the process of sensing the pressure in the pressure chamber and the service chamber through the plurality of pressure sensors, and monitoring changes in stroke value of the pushrod 500 connected to the pressure chamber and the service chamber.

Meanwhile, the control box 610 and the wireless communication module may be disposed inside of the pushrod chamber 320 or outside of the air spring brake chamber, and the plurality of pressure sensors, the control box 610 and the wireless communication module may be electrically connected to a battery of the vehicle, so they may be supplied with power to perform work.

The foregoing description is made to describe the technical spirit of the present disclosure for illustrative purposes, and it is obvious to those skilled in the art that a variety of modifications and change may be made thereto without departing from the essential features of the present disclosure. Therefore, the embodiments disclosed herein are provided to describe the technical spirit of the present disclosure and not intended to be limiting, and the technical spirit and scope of the present disclosure is not limited by the embodiments. The scope of protection of the present disclosure should be interpreted by the appended claims, and it should be interpreted that the scope of protection of the present disclosure covers all the technical spirit within the equivalent scope.

1. A fault diagnostic system of an air spring brake chamber for a vehicle, in which the air spring brake chamber for the vehicle includes a head housing, a bottom housing and an adaptor housing between the head housing and the bottom housing, a piston between the head housing and the adaptor housing, and a diaphragm secured between the adaptor housing and the bottom housing to divide a space between the adaptor housing and the bottom housing,
the fault diagnostic system comprising:
a pressure measurement unit configured to measure a pressure in each of a parking chamber between the piston and the adaptor housing and a service chamber between the adaptor housing and the diaphragm;
a brake lining temperature sensing unit connected to a brake lining to detect a temperature of the brake lining; and
a notification unit configured to generate an alarm about an abnormal situation in the air spring brake chamber for the vehicle based on a pressure measurement value of the pressure measurement unit and a temperature measurement value of the lining temperature sensing unit.

2. The fault diagnostic system of claim 1, wherein the notification unit generates the alarm about the abnormal situation in the air spring brake chamber for the vehicle when a parking pressure value detected in at least one of a plurality of parking chambers at a plurality of wheels of the vehicle is equal to or lower than a predetermined pressure, and a service pressure value detected in at least one of a plurality of service chambers at the plurality of wheels of the vehicle is maintained at or above a predetermined pressure for a predetermined time or a pressure difference of each service chamber is equal to or larger than a predetermined value.

3. The fault diagnostic system of claim 1, wherein the brake lining temperature sensing unit classifies the temperature detected in the brake lining into stages or sets a temperature resistance table and determines the faulty brake when the temperature corresponds to a specific stage or a specific condition.

4. The fault diagnostic system of claim 1, further comprising:
a warning lamp unit configured to receive data from the pressure measurement unit and the brake lining temperature sensing unit and turn on a warning lamp according to the pressure or temperature,
wherein the warning lamp unit provides the data of the corresponding vehicle to a control center or a nearby vehicle when a user did not check although a predetermined time has passed since the warning lamp was turned on.

5. The fault diagnostic system of claim 1, wherein recording is made that an emergency brake has operated when the pressure value detected in the parking chamber drops from a preset unparking pressure down to a minimum instantaneous pressure, or the pressure value detected in the service chamber is equal to or more than a preset emergency high pressure value.
